(19) United States
(12) Patent Application Publication
(10) Pub. No.: US 2013/0002969 A1
(43) Pub. Date: Jan. 3, 2013

(54) VIDEO PROJECTOR

(75) Inventor: Kazuya MINAMI, Osaka (JP)

(73) Assignee: SANYO ELECTRIC CO., LTD., Osaka (JP)

(21) Appl. No.: 13/532,010

(22) Filed: Jun. 25, 2012

(30) Foreign Application Priority Data
Jun. 28, 2011 (JP) 2011-143307

(51) Int. Cl. F04D 13/06; H04N 5/74

(52) U.S. Cl. 348/748; 417/423.9; 348/E05.143

(57) ABSTRACT

A video projector includes a cooling system arranged in a frame accommodating an optical component. The cooling system includes an ambient air drawing unit and a cooling fan. The ambient air drawing unit includes an inlet, through which the ambient air is drawn into the frame, an air filter arranged facing the inlet, and a case that accommodates the air filter and forms an air passage extending from the inlet to an exit side of the air filter. The cooling fan sends the ambient air, which is drawn in by the ambient air drawing unit, to the optical component. The ambient air drawing unit is formed to be movable to a position outside the frame so that the air filter is replaceable in a state in which the ambient air drawing unit is moved to the position outside the frame.

### CROSS-REFERENCE TO RELATED APPLICATIONS

This application is based upon and claims the benefit of priority from prior Japanese Patent Application No. 2011-143307, filed on Jun. 28, 2011, the entire contents of which are incorporated herein by reference.

### BACKGROUND OF THE INVENTION

The present invention relates to a video projector and, more particularly, to a structure for coupling an air filter arranged to face an inlet.

A video projector includes optical components that are heated when transmitting light from a light source lamp. Thus, ambient air is drawn into the video projector to cool the optical component and keep the temperature of the optical components below a tolerable temperature limit.

However, dust may be suspended in the drawn-in air, or cooling air. When dust suspended in the cooling air enters the video projector, the dust adversely affects the quality of the video projector.

In the prior art, to remove dust from the drawn-in air, an air filter is arranged to face an inlet through which ambient air is drawn in. A cooling fan is arranged inward from the air filter.

When the air filter is continuously used, clogging occurs in the air filter. Thus, when the air filter is used for a predetermined time, the air filter is replaced with a new one. Alternatively, the air filter is cleaned and reused. Thus, when designing a structure for coupling the air filter, consideration is made to facilitate the replacement of the air filter.

For example, Japanese Laid-Open Patent Publication No. 2009-3317 describes an air filter arranged in a frame. The air filter is coupled in a removable manner to the frame from the exterior of the frame.

Japanese Laid-Open Patent Publication No. 2010-191167 describes a shutter arranged in the vicinity of a cooling fan near an air filter that is arranged facing an inlet. The shutter closes an ambient air drawing passage when the air filter is replaced.

In the prior art described above, when replacing an air filter, the dust collected on the air filter may fall from the air filter in the area where the air filter is coupled. However, the area in the vicinity of the air filter is small and difficult to clean. Further, dust is collected in the frame on components located in the vicinity of where the air filter is coupled. Thus, the vibration produced when replacing the air filter or changes in the air flow when replacing the air filter may result in dust entering the interior of the frame where the optical components are accommodated.

Such a problem will now be described in detail with reference to drawings schematically showing an ambient air drawing unit.

The structure of Japanese Laid-Open Patent Publication No. 2009-3317 will now be described with reference to FIGS. 11 to 13. Referring to FIG. 11, a frame 101 has a side wall including an inlet 102. A suction grille is arranged in the inlet 102. An air filter 103 is arranged facing the inlet 102. A cooling fan 104 is arranged inward from the air filter 103. The cooling fan 104 includes an outlet that is in communication with an air duct 105 to send cooling air to heat generation components including optical components, such as deflector plates and LCD panels, a light source lamp, and a power supply. In this state, dust d1 is collected on the air filter 103, and dust d2 is collected on components in the vicinity of the air filter 103 in the frame 101.

Referring to FIG. 12, the air filter 103 is fitted into the frame 101 from the exterior and pulled out for removal. Thus, the air filter 103 may be coupled in a removable manner to the frame 101. To replace the air filter 103 in such a structure, when pulling out the air filter 103 from the frame 101 for removal, vibration or the like is produced. This separates the dust d1 from the air filter 103 and some of the dust d2 from the components in the vicinity of the air filter 103. As a result, the separated dust d3 is left in the frame 101.

Further, referring to FIG. 13, the removal of the air filter 103 may disturb the flow of air through the suction grille. Thus, the dust d3, which is separated from the air filter 103 and the components in the vicinity of the air filter 103, may flow inward from the air filter 103. As a result, the dust d3 may be sent to the optical components through the air duct 105 when the cooling fan 104 restarts operation.

The structure of Japanese Laid-Open Patent Publication No. 2010-191167 will now be described with reference to FIGS. 14 to 17. Same reference numerals are given to those components that are the same as the corresponding components of Japanese Laid-Open Patent Publication No. 2009-3317. Such components will not be described. As shown in FIG. 14, a shutter 106 is arranged between the air filter 103 and the cooling fan 104. When the air filter 103 is removed, the shutter 106 prevents the dust d3, which is separated from the air filter 103 and the components in the vicinity of the air filter 103, from entering the inner side of the air filter 103. Further, referring to FIG. 15, the shutter 106 is formed to close when the air filter 103 is removed. Accordingly, referring to FIG. 16, even if the flow of air is disturbed when the air filter 103 is removed, the shutter 106 blocks the dust d3, which is separated from the air filter 103 and the components in the vicinity of the air filter 103, and prevents the dust d3 from entering the inner side of the shutter 106.

However, referring to FIG. 17, when the air filter 103 is coupled to the frame 101 and the shutter 106 opens to draw in ambient air, the dust d3 collected on the shutter 106 may be drawn into the cooling fan 104 when the cooling fan 104 restarts operation. As a result, the dust d3 may be sent to the optical components through the air duct 105.

In this manner, in the video projector of the prior art, when the cooling fan 104 restarts operation, the dust d3, which was separated from the air filter 103 during removal of the air filter 103, is moved through the air duct 105 together with the dust d2, which was collected on the components in the vicinity of the air filter 103, into the area accommodating the optical components.

### SUMMARY OF THE INVENTION

One aspect of the present invention is a video projector including a frame and a cooling system. The frame accommodates an optical component including a light modulator that modulates light emitted from a light source lamp based on an image signal. The cooling system is arranged in the frame. The cooling system includes an ambient air drawing unit and a cooling fan. The ambient air drawing unit includes elements arranged integrally to form a drawing portion that draws in ambient air. The elements of the drawing portion includes an inlet through which the ambient air is drawn into the frame, an air filter arranged facing the inlet, and a case that accommodates the air filter and forms an air passage extending from the inlet to an exit side of the air filter. The cooling fan sends the ambient air, which is drawn in by the ambient air drawing unit, to the optical component. The ambient air drawing unit is formed to be movable to a position outside the frame so that the air filter is replaceable in a state in which the ambient air drawing unit is moved to the position outside the frame.

A further aspect of the present invention is an ambient air drawing unit that draws ambient air into a frame. The ambient air drawing unit includes an inlet through which the ambient air is drawn into the frame. An air filter is arranged to face the inlet. A case accommodates the air filter and forms an air passage extending from the inlet to an exit side of the air filter. The ambient air drawing unit is formed to be movable to a position outside the frame so that the air filter is replaceable in a state in which the ambient air drawing unit is moved to the position outside the frame.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing an ambient air drawing unit in a video projector according to a first embodiment;

FIG. 2 is a perspective view showing the ambient air drawing unit of FIG. 1 arranged outside a frame;

FIG. 3 is a schematic diagram showing dust collected in the ambient air drawing unit of FIG. 1 before an air filter is replaced;

FIG. 4 is a schematic diagram showing the ambient air drawing unit of FIG. 1 in a state pivoted and arranged outside the frame;

FIG. 5 is a schematic diagram showing the ambient air drawing unit of FIG. 1 in a state in which the air filter is removed;

FIG. 6 is a schematic diagram showing a state in which a new air filter is coupled to the ambient air drawing unit of FIG. 1;

FIG. 7 is a perspective view showing an ambient air drawing unit in a video projector according to a second embodiment;

FIG. 8 is a perspective view showing the ambient air drawing unit of FIG. 7 arranged outside a frame;

FIG. 9 is a schematic diagram showing the ambient air drawing unit of FIG. 7 in a state before removal from the frame;

FIG. 10 is a schematic diagram showing the ambient air drawing unit of FIG. 7 in a state removed from the frame;

FIG. 11 is a schematic diagram showing dust collected in an ambient air drawing unit before an air filter is replaced in one prior art example of a video projector;

FIG. 12 is a schematic diagram showing dust collected in the ambient air drawing unit when the air filter is removed in the video projector of FIG. 11;

FIG. 13 is a schematic diagram showing the movement of dust into an air duct in the ambient air drawing unit when the flow of air is disturbed during removal of the air filter in the video projector of FIG. 11;

FIG. 14 is a schematic diagram showing dust collected in an ambient air drawing unit before an air filter is replaced in a further prior art example of a video projector;

FIG. 15 is a schematic diagram showing dust collected in the ambient air drawing unit when the air filter is removed in the video projector of FIG. 14;

FIG. 16 is a schematic diagram showing a shutter functioning in the ambient air drawing unit when the air filter is removed in the video projector of FIG. 14; and

FIG. 17 is a schematic diagram showing dust collected in the ambient air drawing unit after the air filter is replaced in the video projector of FIG. 14.

### DETAILED DESCRIPTION OF THE INVENTION

### First Embodiment

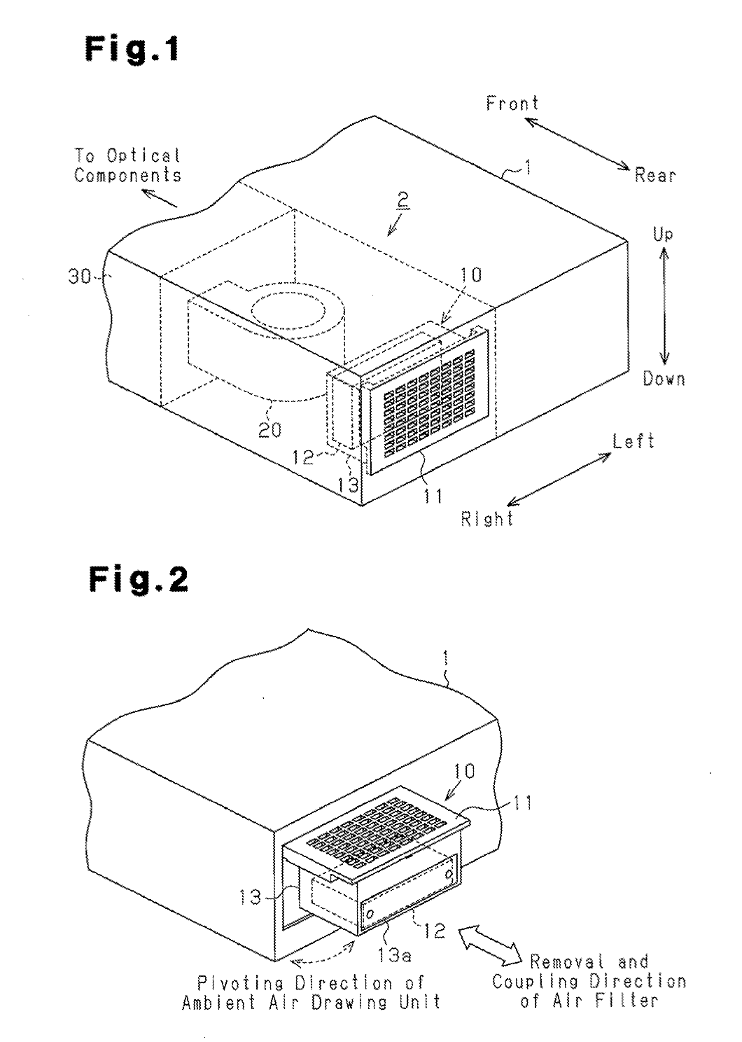

A video projector according to a first embodiment of the present invention will now be described with reference to FIGS. 1 to 6. In the description hereafter, the upward, downward, leftward, rightward, frontward, and rearward directions are as marked in FIG. 1, which shows the video projector in a state arranged on a floor.

The video projector, which serves as an electronic device, is, for example, a three-chip LCD projector including a frame 1 and a cooling system 2. The frame 1 accommodates optical components such as light modulators, which light-modulates the light emitted from a light source lamp based on an image signal. The cooling system 2 is arranged in the frame 1, draws in ambient air, and sends the ambient air to the optical components.

The cooling system 2 includes an ambient air drawing unit 10 and a cooling fan 20. The ambient air drawing unit 10 includes a drawing portion that draws in ambient air through a rear surface of the frame 1. The cooling fan 20 sends the ambient air, which is drawn in by the ambient air drawing unit 10, to the optical components. The cooling system 2 also includes an air duct 30, which delivers the ambient air discharged from the cooling fan 20 to the optical components. In the first embodiment, a sirocco fan is used as am example of the cooling fan 20.

The ambient air drawing unit 10 includes a plurality of elements that are arranged integrally so as to form the drawing portion. As the elements of the drawing portion, the ambient air drawing unit 10 includes an inlet 11, through which ambient air is drawn into the frame 1, an air filter 12, which is arranged facing the inlet 11, and a case 13, which accommodates the air filter 12 and forms an air passage extending from the inlet 11 to the exit side of the air filter 12. In the first embodiment, a suction grille is used as an example of the inlet 11.

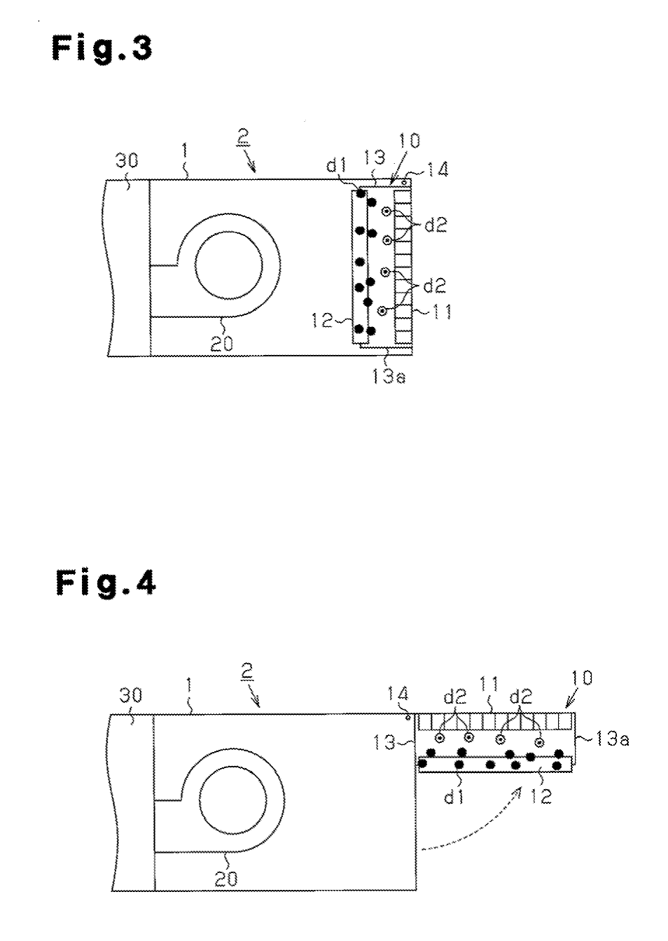

The ambient air drawing unit 10 is formed to be movable to a position outside the frame 1. In this example, as shown in FIG. 2, the ambient air drawing unit 10 is formed to be rectangular as viewed from an outer side of the inlet 11. Further, the ambient air drawing unit 10 is pivotal about a pivot shaft 14 (refer to FIG. 3), which is arranged on one side (upper side in the first embodiment) of the rectangular ambient air drawing unit 10, like a door on hinges toward the outer side of the ambient air drawing unit 10.

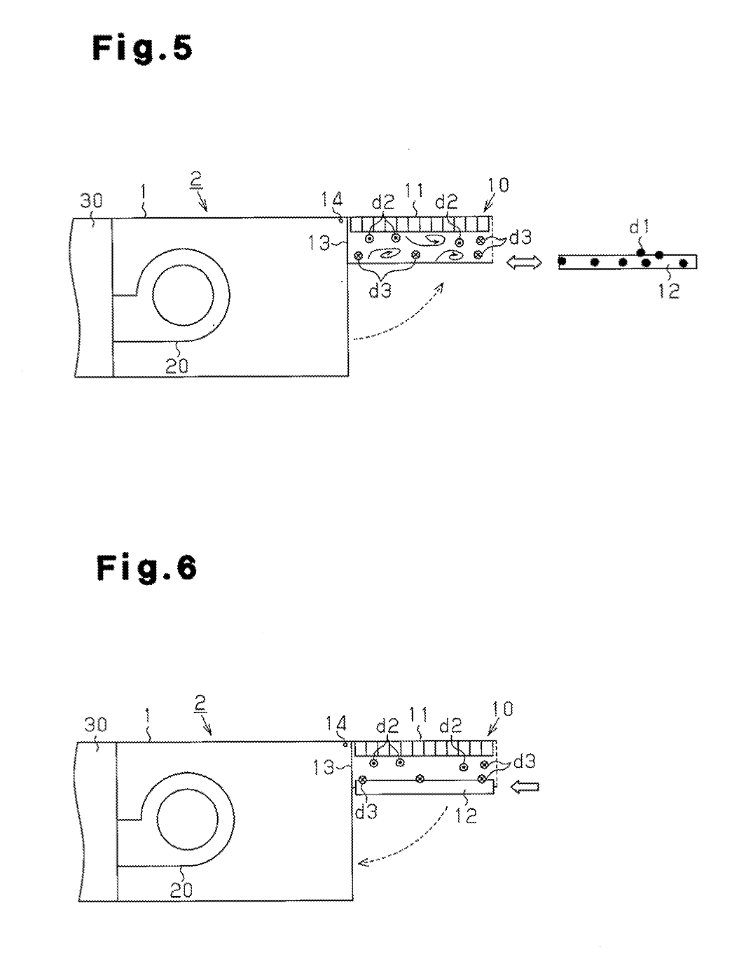

Referring to FIG. 5, when the ambient air drawing unit 10 is moved to a position outside the frame 1, a side cover 13a (refer to FIG. 2) is removable from the case 13. This allows the air filter 12 to be slid in the horizontal direction and removed from the ambient air drawing unit 10.

The operation of the video projector in the first embodiment will now be described.

When the air filter 12 is removed to be replaced with a new one or a cleaned one, the ambient air drawing unit 10 located inside the frame 1 as shown in FIG. 3 is pivoted like a hinged door and located to a position outside the frame 1 as shown in FIG. 4. In this state, in the ambient air drawing unit 10, dust d1 is collected on the air filter 12, and dust d2 is left collected on the components (for example, the case 13, the inlet 11, or the other components not shown) in the vicinity of the air filter 12.

Then, the side cover 13a is removed. This allows the air filter 12 to be slid and removed in the horizontal direction as shown in FIG. 5. Here, the vibration produced by the removal of the air filter 12 separates some of the dust d1 and d2 from the air filter 12 and components in the vicinity of the air filter 12 as dust d3. The dust d3 remains in the case 13 of the ambient air drawing unit 10. The dust d3, separated during the removal of the air filter 12, may fall down from the case 13. However, in such a case, the dust d3 will fall outside the frame 1.

Then, referring to FIG. 6, a new air filter 12 or a cleaned air filter 12 is slid into ambient air drawing unit 10 in the horizontal direction. Further, the ambient air drawing unit 10 is pivoted back to its original position. This completes the replacement of the air filter 12. When the air filter 12 is coupled in this manner, the case 13 holds, between the inlet 11 and the air filter 12, the dust d3, which is separated from the air filter 12 and components in the vicinity of the air filter 12 and left in the case 13, and the dust d2, which is left collected on components near the air filter 12. Accordingly, when the ambient air drawing unit 10 is coupled back to the frame 1 at a predetermined location, the dust d2 and d3 left in the ambient air drawing unit 10 does not enter the inner side of the air filter 12 even when the cooling fan 20 is activated.

The video projector of the first embodiment has the advantages described below.

(1) When the air filter 12 is removed to be replaced with a new one or a cleaned one, some of the dust d3 separated from the air filter 12 and components in the vicinity of the air filter 12 is left in the ambient air drawing unit 10 and some of the dust d3 falls out from the ambient air drawing unit 10. Here, when a new air filter 12 is coupled, the dust d3 left in the ambient air drawing unit 10 is entrapped in the ambient air drawing unit 10 together with the dust d2 left collected on the components in the vicinity of the air filter 12. Further, the air filter 12 is removed at a position outside the frame 1. Thus, even when the dust d3 falls out of the ambient air drawing unit 10, the dust d3 will fall outside the frame 1. This essentially prevents the dust d3 from entering the frame 1. As a result, when replacing the air filter 12, the dust d3 separated from the air filter 12 and components in the vicinity of the air filter 12 and the dust d2 collected on the components in the vicinity of the air filter 12 are prevented from entering the frame 1 that accommodates the optical components.

(2) The ambient air drawing unit 10 is formed to be rectangular as viewed from the outer side of the inlet 11 and pivotal about the pivot shaft 14, which is arranged on one side of the rectangular ambient air drawing unit 10, like a door on hinges. This facilitates movement of the air filter 12 to a position outside the frame 1.

(3) When the ambient air drawing unit 10 is pivoted to a position outside the frame 1, the air filter 12 is slidable out of and into the ambient air drawing unit 10. This facilitates the removal and coupling of the air filter 12.

### Second Embodiment

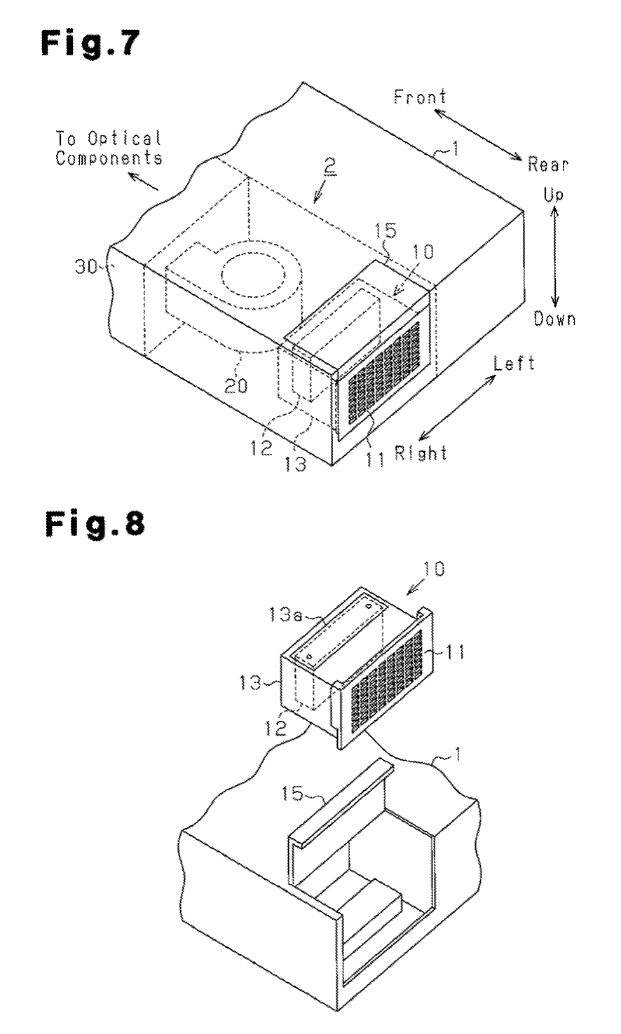

A video projector according to a second embodiment of the present invention will now be described with reference to FIGS. 7 to 10.

In the first embodiment, the ambient air drawing unit 10 is pivoted like a door on hinges to move the ambient air drawing unit 10 to a position outside the frame 1. In contrast, in the second embodiment, the ambient air drawing unit 10 is entirely removable outward from the frame 1. Same reference numerals are given to those components that are the same as the corresponding components of the first embodiment. Such components will not be described in detail.

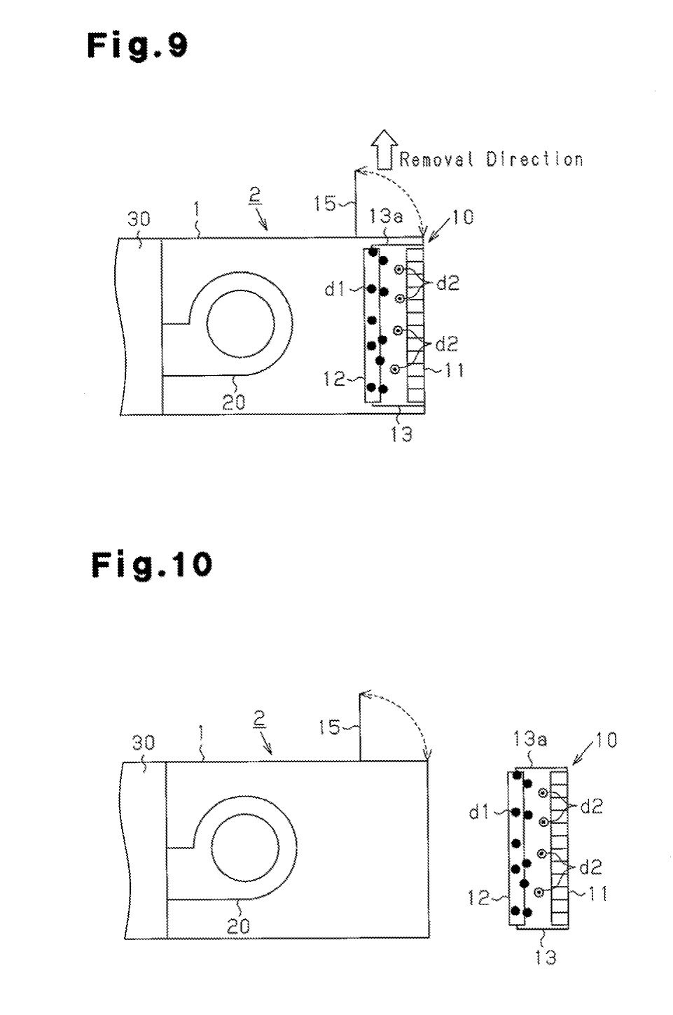

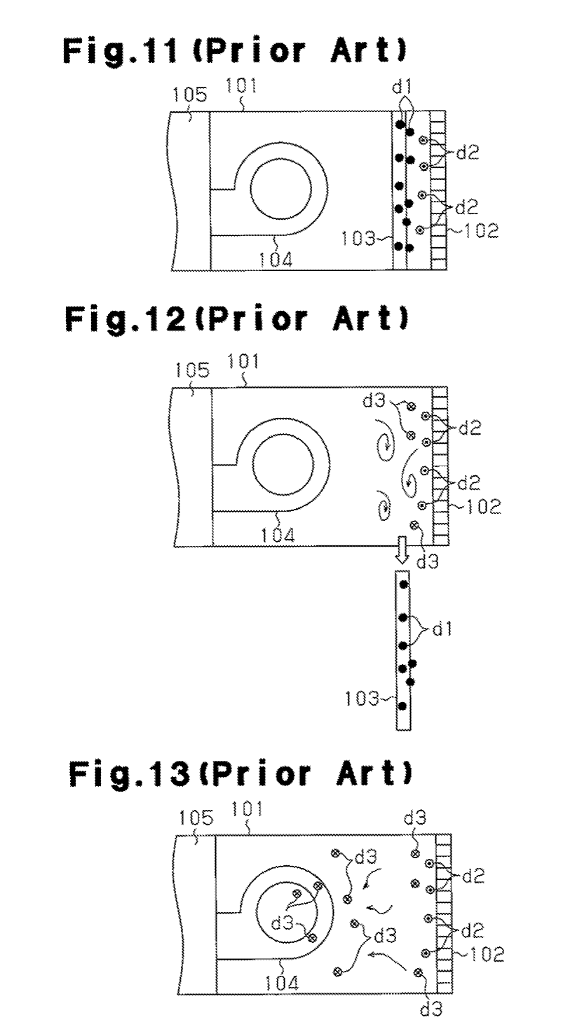

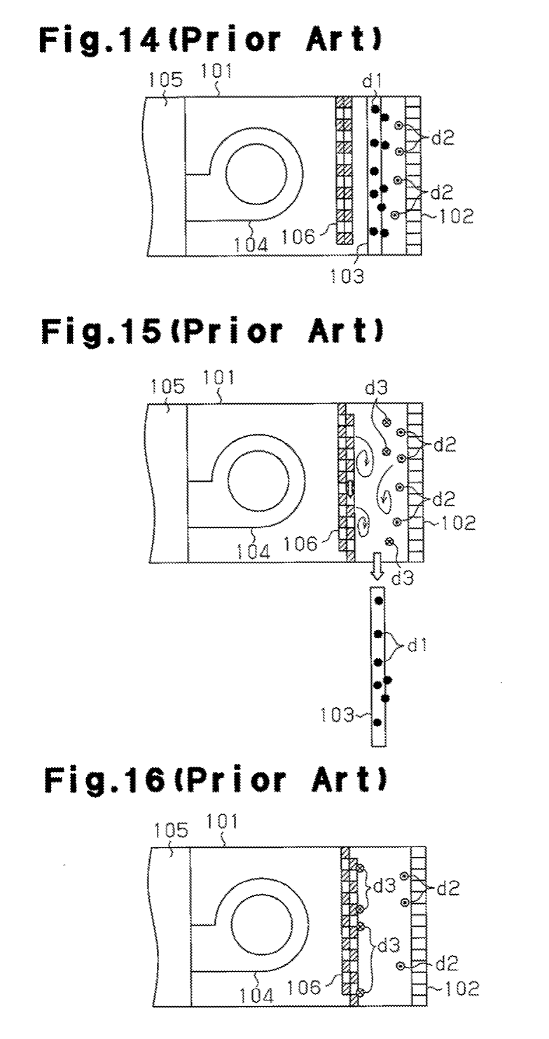

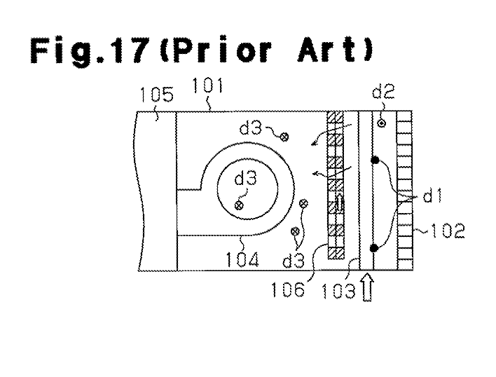

As shown in FIGS. 7, 8, and 9, a lid 15 is arranged in the upper surface of the frame 1. The ambient air drawing unit 10 is formed so that it entirely be slidable out of the frame 1 as shown by the arrow in FIG. 9.

When the ambient air drawing unit 10 is pulled out of the frame 1 and arranged, for example, in the state shown in FIG. 10, removal of the side cover 13a from the case 13 allows for the air filter 12 to be slid out of the ambient air drawing unit 10 in the same manner as the first embodiment. In the example shown in FIG. 8, the side cover 13a is coupled to an upper portion of the case 13. However, the side cover 13a does not have to be coupled to the upper portion of the case 13 and may be coupled to a lower portion of the case 13.

The operation of the video projector in the second embodiment will now be described.

When removing the air filter 12 to replace the air filter 12, as shown in FIGS. 8 and 9, the lid 15 in the upper surface of the frame 1 is first opened. Then, as shown by the arrow in FIG. 9, the ambient air drawing unit 10 is slid upward and pulled out of the frame 1. As shown in the state of FIG. 10, this completely separates the ambient air drawing unit 10 from the frame 1. That is, the ambient air drawing unit 10 may be moved to any position independently from the video projector. Accordingly, after the ambient air drawing unit 10 becomes movable in such a manner, removal of the side cover 13a allows for removal of the air filter 12 like in the first embodiment.

As shown in FIG. 9, in the ambient air drawing unit 10 before the air filter 12 is replaced, dust d1 is collected on the air filter 12, and dust d2 is left collected on the components in the vicinity of the air filter 12. However, referring to FIG. 10, the air filter 12 is replaced in a state in which the ambient air drawing unit 10 is removed from and located outside the frame 1. When the air filter 12 of the ambient air drawing unit 10 is replaced with a new one or a cleaned one, in the same manner as the first embodiment, some of the dust d3 separated from the air filter 12 and components in the vicinity of the air filter 12 is left in the ambient air drawing unit 10 and some of the dust d3 falls out from the ambient air drawing unit 10. Here, when a new air filter 12 is coupled, the dust d3 left in the ambient air drawing unit 10 is entrapped in the ambient air drawing unit 10 together with the dust d2 left collected on the components in the vicinity of the air filter 12. Further, the air filter 12 is removed at a position outside the frame 1. Thus, even when the dust d3 falls out of the ambient air drawing unit 10, the dust d3 will fall outside the frame 1. As a result, the dust d3 separated from the air filter 12 and components in the vicinity of the air filter 12 and the dust d2 collected on the components in the vicinity of the air filter 12 do not enter the frame 1.

In addition to advantage (1) of the first embodiment, the video projector of the second embodiment has the advantages described below.

(4) The ambient air drawing unit 10 is entirely removed from the frame 1. In other words, the ambient air drawing unit 10 is entirely separated from the frame 1 when removed. Accordingly, the air filter 12 is removed from and coupled to the ambient air drawing unit 10 at a location separated from the frame 1. As a result, the dust d3 separated from the air filter 12 and components in the vicinity of the air filter 12 and the dust d2 left collected on the components in the vicinity of the air filter 12 are effectively prevented from entering the frame 1.

(5) The ambient air drawing unit 10 is formed to be slid out of and into the frame 1. This facilitates the removal and coupling of the ambient air drawing unit 10.

It should be apparent to those skilled in the art that the present invention may be embodied in many other specific forms without departing from the spirit or scope of the invention. Particularly, it should be understood that the present invention may be embodied in the following forms.

The filtering method of the air filter 12 is not particularly limited. The air filter 12 may be a normal filter or a high-capacity filter that mechanically separates dust. Alternatively, the air filter 12 may be a combination of a normal filter and a high-capacity filter.

The air filter 12 is slid into and fixed to the ambient air drawing unit 10. However, the air filter 12 may be fixed in any manner. For example, screws may be used to fix the air filter 12. Alternatively, another mechanism such as a fitting mechanism including hooks may be used to fix the air filter 12. It is preferable that the air filter 12 be manually fixed in a simple manner to the ambient air drawing unit 10.

To move the ambient air drawing unit 10 out of the frame 1, the first embodiment pivots the ambient air drawing unit 10 and the second embodiment slides the ambient air drawing unit 10. However, the movement of the ambient air drawing unit 10 is not limited to the foregoing description. For example, screws may be used to fix the ambient air drawing unit 10. Alternatively, a fitting mechanism including hooks may be used to fix the ambient air drawing unit 10.

The cooling system 2 of each of the above embodiments includes a single route through which ambient air is delivered to the optical components. However, the cooling fan 20 and the air duct 30 may be arranged in each of a plurality of routes extending from a single ambient air drawing portion. Further, some or all of the cooling fans 20 do not have to be arranged in the air ducts 30.

When the cooling system 2 does not include the air duct 30, the cooling fan 20 may be an axial flow fan instead of a sirocco fan. Further, the cooling fan 20 is not limited to a drawing type and may be of a type that circulates ambient air through the ambient air drawing unit 10 to optical components by discharging air from the frame 1.

The suction grille arranged in the inlet 11 may just include a large number of small holes or be ornamental to improve the outer design by forming a large number of slits.

The present invention may be applied to various types of video projectors. For example, the present invention is applied to a three-chip LCD projector in the first and second embodiments. However, the present invention may be applied to a video projector including a different type of image light generation system or a Digital Light Processing (DLP, registered trademark of Texas Instruments Inc.) projector.

The present examples and embodiments are to be considered as illustrative and not restrictive, and the invention is not to be limited to the details given herein, but may be modified within the scope and equivalence of the appended claims.

1. A video projector comprising:
a frame that accommodates an optical component including a light modulator that modulates light emitted from a light source lamp based on an image signal; and
a cooling system arranged in the frame, wherein the cooling system includes:
an ambient air drawing unit including elements arranged integrally to form a drawing portion that draws in ambient air, the elements of the drawing portion includes
an inlet through which the ambient air is drawn into the frame,
an air filter arranged facing the inlet, and
a case that accommodates the air filter and forms an air passage extending from the inlet to an exit side of the air filter; and
a cooling fan that sends the ambient air, which is drawn in by the ambient air drawing unit, to the optical component, wherein
the ambient air drawing unit is formed to be movable to a position outside the frame so that the air filter is replaceable in a state in which the ambient air drawing unit is moved to the position outside the frame.

2. The video projector according to claim 1, wherein the ambient air drawing unit is rectangular as viewed from an outer side of the inlet and pivotal outward from the frame about a pivot shaft arranged on one side of the rectangular ambient air drawing unit like a hinged door.

3. The video projector according to claim 2, wherein the ambient air drawing unit is formed so that the air filter can be removed from and coupled to the ambient air drawing unit when the ambient air drawing unit is pivoted outward from the frame.

4. The video projector according to claim 1, wherein the ambient air drawing unit can entirely be removed from and coupled to the frame.

5. The video projector according to claim 1, wherein the ambient air drawing unit is arranged so that the drawing portion is movable to a position outside the frame.

6. An ambient air drawing unit that draws ambient air into a frame, the ambient air drawing unit comprising:
an inlet through which the ambient air is drawn into the frame;
an air filter arranged facing the inlet; and
a case that accommodates the air filter and forms an air passage extending from the inlet to an exit side of the air filter, wherein
the ambient air drawing unit is formed to be movable to a position outside the frame so that the air filter is replaceable in a state in which the ambient air drawing unit is moved to the position outside the frame.
